(19) United States
(12) Patent Application Publication
(10) Pub. No.: US 2026/0208000 A1
(43) Pub. Date: Jul. 23, 2026

(54) ROPE MANAGEMENT TOOL

(71) Applicant: International Safety Components Ltd, Bangor (GB)

(72) Inventor: Jason Korkidakis, Bangor (GB)

(21) Appl. No.: 19/035,565

(22) Filed: Jan. 23, 2025

(51) Int. Cl. A63B 29/02; A45F 5/00; A45F 5/02; A62B 35/00; A63B 27/00

(52) U.S. Cl. CPC A63B 29/02; A45F 5/021; A62B 35/0025; A63B 27/00; A45F 2005/002; A62B 35/0012

(57) ABSTRACT

A tool for managing a rope associated with a waist belt of an arborist or a climber's harness includes a main body having a proximal end configured to attach to the waist belt or climber's harness and a distal end configured to point away from the arborist or climber; a plurality of fingers extending outwardly from the main body of the tool in a descending stair-like array, the plurality of fingers including a topmost finger configured to be nearest to the user of the tool and a lowermost finger extending furthest from the user, the plurality of fingers each configured to receive a section of the rope, each finger having a generally serpentine shape defining in conjunction with an adjacent finger a rope-receiving slot with a closed end in the form of a cavity configured to receive a section of the rope, a tip of each finger being bendable for inserting or releasing a section of the rope.

### FIELD OF THE INVENTION

This invention relates to ropes used especially, but not exclusively, by arborists and may find use in other activities involving climbing including rock climbing.

In this patent specification the term “rope” is meant to include lanyards, lines, cables and other filament-like means for lifting and lowering objects including climbers and their tools, which may typically include in the case of arborists, chainsaws and other hand-held cutting equipment.

### BACKGROUND OF THE INVENTION

Arborists often require the use of multiple ropes when working on large trees or groups of trees that permit work to be carried out at a common height around the or each tree before the arborist ascends to a new height at which to carry out further work within the canopy as necessary, the process continuing until the work has been completed and the arborist has to descend on one of the ropes with the aid of descenders such as Prussik knots and/or mechanical descenders which grip the rope whilst allowing controlled descent. As will be appreciated by those skilled in the art, when carrying out such work the arborist must have readily available i.e. within reaching distance at any given height, tools such as hand saws and loppers and for heavier items such as chainsaws it is common practice to use pulleys and carabiners connected to a separate, usually thinner, rope system. Thus if, say, a group of three trees are to be pruned at the same time the arborist can arrange for three main safety ropes to be used, one for each tree, such that when work on one tree at a given height is complete the arborist can simply swing sideways to another tree and connect to the next main safety rope and can either disconnect from the original main safety rope or keep it connected as a back-up safety rope, to then continue working at the same height, and so on.

The use of single or multiple ropes, all of which necessarily have to be longer than the height of the or each tree, brings with it the problem of potential entanglement and/or confusion as to which loop of rope is the next one from a single rope or which rope is connected to which tree where multiple safety ropes are being used. In turn, this has resulted in some arborists using rope management equipment, usually attached to the waist belt of the arborist or a convenient part of the climber's harness.

The Notch Sidekick Lanyard Manager is for use with a single rope only, meaning that when used for work around a tall tree the necessary length of the rope makes it more likely to become entangled with branches and twigs below and, if the arborist is working dynamically by carrying out work across several trees, multiple such tools must be employed, making it difficult to identify which rope is applicable to which tree.

The K1 Keeper tool requires the removal of three pulleys prior to the placement of a single rope around the pulley axles, for which a special tool is provided, after which the pulleys are replaced and fastened to ensure that they remain on the axles, after which the tool is connected to the climber's harness.

While the foregoing prior art equipment for managing the temporary capture of various sections of rope by the arborist can help to avoid problems such as entanglement with, typically, small tree branches on larger branches that remain after the work has been completed, they are somewhat complicated to use, especially if the arborist has only one hand free for use at height in the tree canopy.

The present invention is derived from the realisation that there is a need to greatly simplify the issue of rope identification and management for arborists in particular in which the foregoing disadvantages are obviated.

According to a first aspect of the invention there is provided a rope management tool for arborists using ropes while wearing a waist belt or climber's harness, the tool having a main body portion with a proximal end attached or attachable to the waist belt or harness, and a distal end pointing away from the arborist, a plurality of bendable fingers extending outwardly from the body portion of the tool in a descending stair-like generally vertical array, with the topmost finger being nearest to the arborist and the lowermost finger extending furthest from the arborist, whereby to permit visual identification of each section of rope between adjacent fingers, each finger in the array being of generally Serpentine shape with which to define in conjunction with an adjacent finger a rope-receiving slot with a closed end, into which slot a respective section of rope can be received and below which the section of rope can be stored in a cavity at the base of the slot, the tip of each finger being bendable single-handedly for inserting or releasing a portion of rope from each slot as required.

According to a second aspect of the invention there is provided a rope management tool for climbers when wearing waist belts or climbing harnesses, the tool having a proximal end attached or attachable to the waist belt or climbing harness and a distal end pointing away from the climber, an array of fingers extending outwardly from the distal end of the tool and arranged in a stair-like configuration, with the topmost finger being nearest the climber and the lowermost finger being furthest, each adjacent pair of fingers defining therebetween a slot with a closed end in the form of a cavity for receiving therein a mid-line section of rope, at least the tip of each finger being bendable by the climber to afford access to the slot for a mid-line section of rope to be stored at the closed end of the slot.

According to a third aspect of the invention there is provided a combination of a climber's waist belt or harness to which has been permanently fixed the rope management tool of the first and second aspects of the invention, preferably by including integrally formed formations such as flaps by which it is attached to the waist belt or harness, such as by being sewn or riveted thereto.

With this arrangement the arborist, or other type of climber if not an arborist, is able to store individual mid-line sections or loops of a rope in the slots between respective fingers before or when working at height on a single tree or mid-line sections or loops of separate ropes when working dynamically on several trees at the same height, in each case the user being conveniently able to grip, either directly or through a rope ascender, the main safety rope with one hand while conveniently accessing and manipulating stored sections or loops of rope with the other hand.

Preferably, the fingers of the rope management tool are of generally Serpentine shape in which the rear part of the lower “tail” forms in conjunction with the corresponding front part of an adjacent finger a slot with an enlarged or bulbous lower end in the form of a cavity into which a section or loop of the rope can be pressed when the tip of the finger is bent away from the adjacent finger such that upon release of pressure on the finger the slot releasably captures the section of rope in the cavity at the closed lower end thereof and to release the rope upon bending the finger to open the slot.

Conveniently, the rope management tool of the invention includes an accessory slot, preferably in the form of a curvilinear or arcuate hole, behind and below some or all of the fingers, within which accessory slot carabiners and other accessories such as pulleys can be temporarily stored, and above the array of fingers an inwardly pointing hook is provided for temporary storage of connectors such as carabiners connected to the working end of lanyard's or the trailing end of the main safety rope for better work positioning and for temporarily holding anything else deemed appropriate.

Where the rope management tool is detachable from the waist belt or climbing harness it preferably includes a pair of jaws with teeth for gripping the belt or harness, the jaws being closable semi-permanently by the use of a closable fastener such as a metal fastener of the Chicago or barrel nut and bolt type with no outwardly visible screw threads, whereby to prevent or inhibit any significant wear caused by screw threads that would otherwise be exposed.

Where the rope management tool is permanently attached to a waist belt or climbers harness it may include in the proximal region integrally formed flaps extending from either side of the tool and permitting it to be attached by being sewn thereto or fixed by rivets such that the inside of the waist belt or climbers harness is generally smooth and, accordingly, the invention also extends to the combination of such a rope management tool attached to a waist belt or climbers harness, or multiple such tools attached thereto.

The tool is preferably made primarily as a one-piece plastics moulding (apart from the aforesaid threaded fastener), using a suitably strong but bendable plastics such as thermoplastic urethane (TPU). The lightweight nature of such plastics permits the use of multiple such rope management tools by the arborist, such as where a group of trees are being worked on at the same time at the same height, using a separate safety rope for each tree, thereby enabling the arborist to easily identify all three safety ropes and associated lanyards, by each being reduced in effective length when looped over and between the fingers of a respective tool at regular intervals and pressed into the closed slot created therebetween, thereby enabling the arborist to ascend the tree with several relatively short loops of the same rope being carried by the same rope management tool so as to minimise the risk of entanglement with tree branches or twigs.

### BRIEF DESCRIPTION OF THE DRAWINGS

The invention will now be described, by way of example only, with reference to the accompanying drawings in which:

FIG. 1 is a side view of the tool according to the invention,

FIG. 2 is a perspective view of the tool of FIG. 1 being mounted on the waist belt of an arborist (not shown),

FIG. 3 is a perspective view of the tool in FIG. 1 mounted on the waist belt of an arborist and about to be secured thereto by a metal fastener,

FIG. 4 is a perspective view of the tool of FIG. 1 mounted and secured on the waist belt of an arborist and receiving a mid-line portion of climbing rope,

FIG. 5 is a perspective view corresponding to that of FIG. 4 in which the climbing rope has been received and secured between a pair of fingers of the tool,

FIG. 6 is a perspective view corresponding to that of FIG. 5 after receiving four mid-line portions of climbing rope,

FIG. 7 shows how a carabiner can also be securely attached to the tool of FIG. 1 for carrying e.g. tools (not shown),

FIG. 8 shows how a carabiner can also be temporarily attached to the tool of FIG. 1, and

FIG. 9. is a perspective view of the tool of FIG. 1 mounted on and secured to the climbing harness of a rope climber.

### DETAILED DESCRIPTION OF THE DRAWINGS

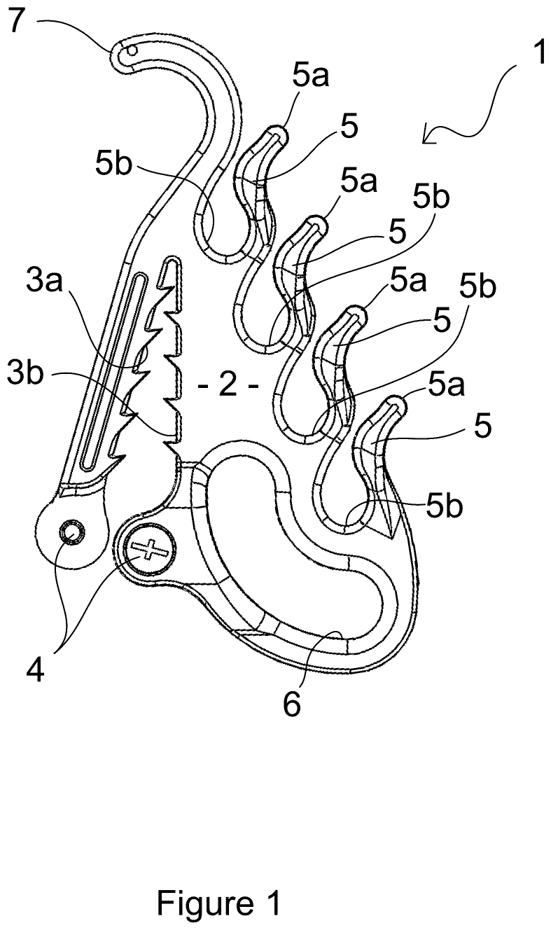

In FIG. 1, there is shown a side view of a rope management tool (1) with a main body portion (2) which includes at the rearward or proximal end relative to the wearer (not shown) of the tool a bendable toothed lower jaw (3a) and a fixed toothed upper jaw (3b) between which the waist belt or harness of an arborist can be inserted and secured thereto after the lower jaw (3a) has been closed against the upper jaw (3b) and secured in place by means of a threaded barrel nut and bolt fastener (4).

At the forward or distal end of the tool (1) are a set of four flexible fingers (5) above an accessory slot in the form of a curvilinear hole (6) at the lower end of the tool and a rearwardly facing inverted hook (7) at the upper end of the tool. The fingers (5) are of generally Serpentine shape with bendable fingertips (5a) and a generally bulbous and closed end forming a cavity (5b) for temporarily storing sections of rope and also forming part of the body portion (2). The fingers (5) are arranged in a staircase configuration with the lowermost finger jutting out furthest from the distal end and the uppermost finger the least. This is a particularly convenient vertical arrangement which not only allows for visual inspection of sections of rope temporarily stored on the tool but also their unhindered removal or replacement as necessary. This may be contrasted with the prior art devices D1 and D2 described earlier which provide for generally horizontal storage and management of sections of a single rope.

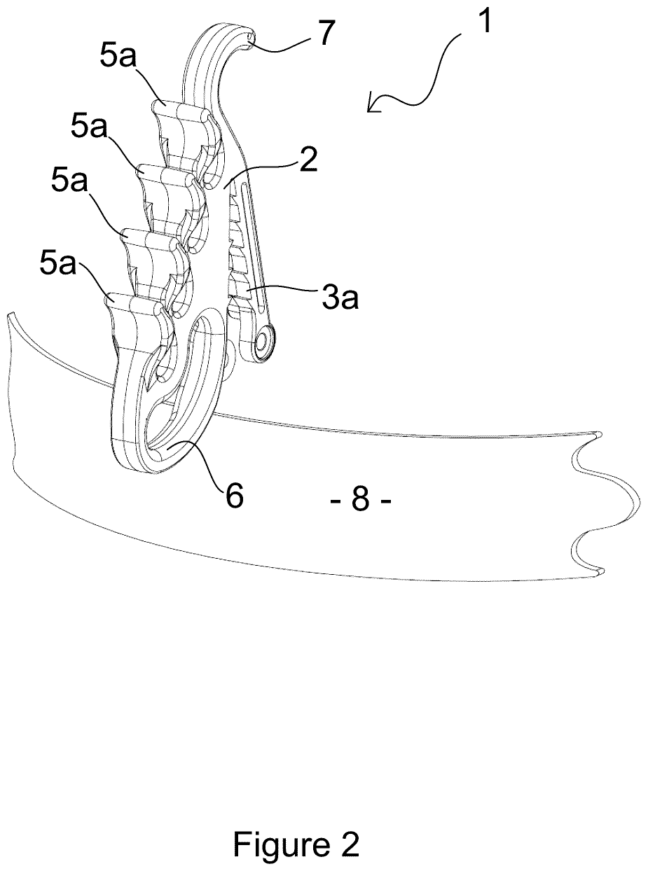

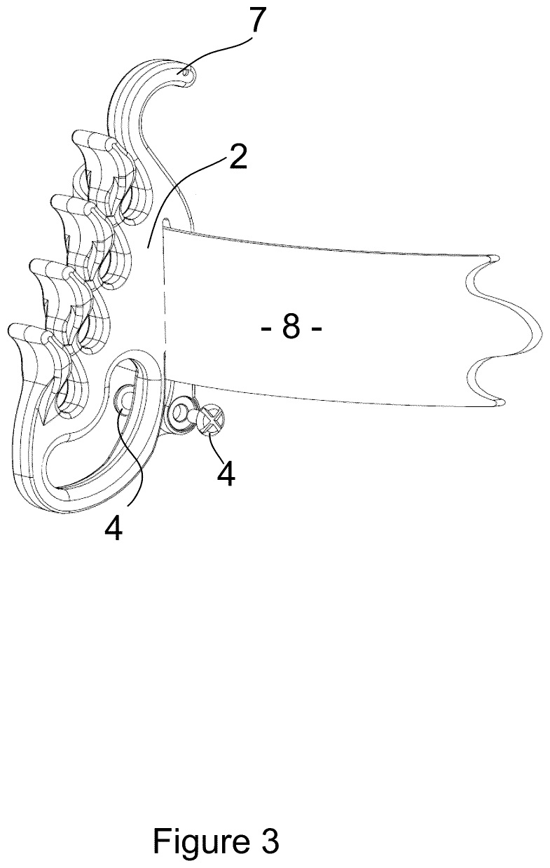

FIG. 2 shows the rope management tool as it is being mounted on the waist belt (8) of an arborist, in which it will be seen that the normally open jaws (3a, 3b) allow it to be easily inserted to the extent shown in FIG. 3, permitting the barrel fastener (4) shown in FIG. 3 to be inserted and fastened to thereby secure the tool to the belt (8).

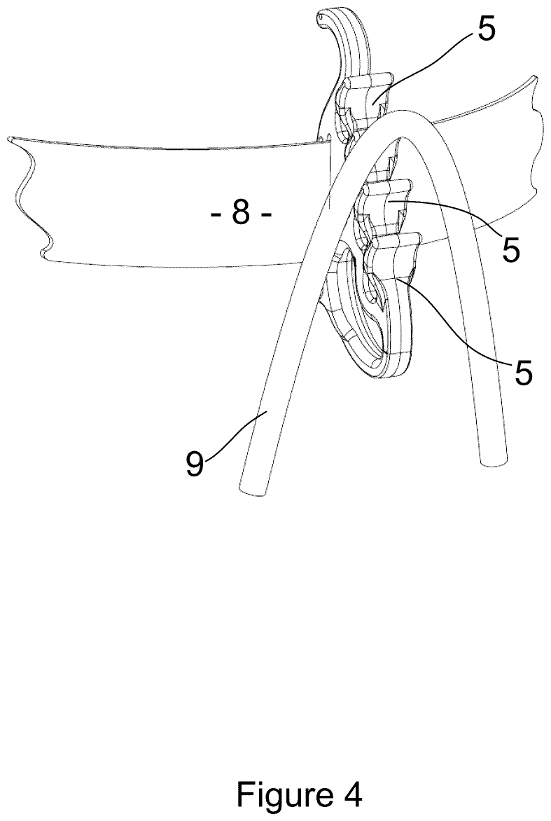

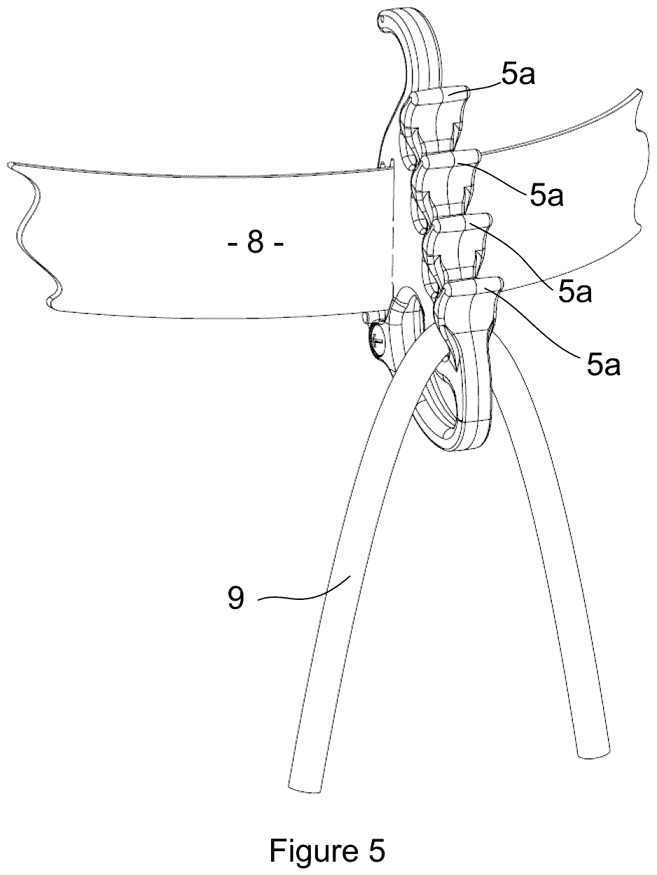

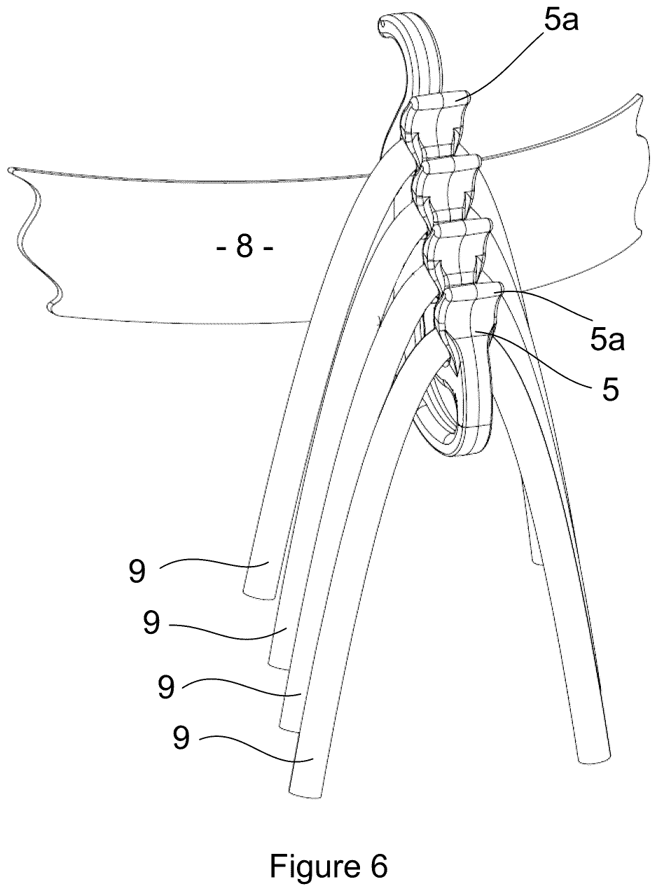

As shown in FIG. 4, the foregoing permits a mid-line section of climbing rope (9) to be positioned above and between respective fingers (5) of the tool whereafter the arborist is able to open the space between adjacent fingers by bending the tip of the lowermost finger to allow the section of rope to be easily pressed therebetween for temporary storage in the manner as shown in FIG. 5 to the extent shown in FIG. 6, where four looped sections of rope have been neatly stored between adjacent fingers.

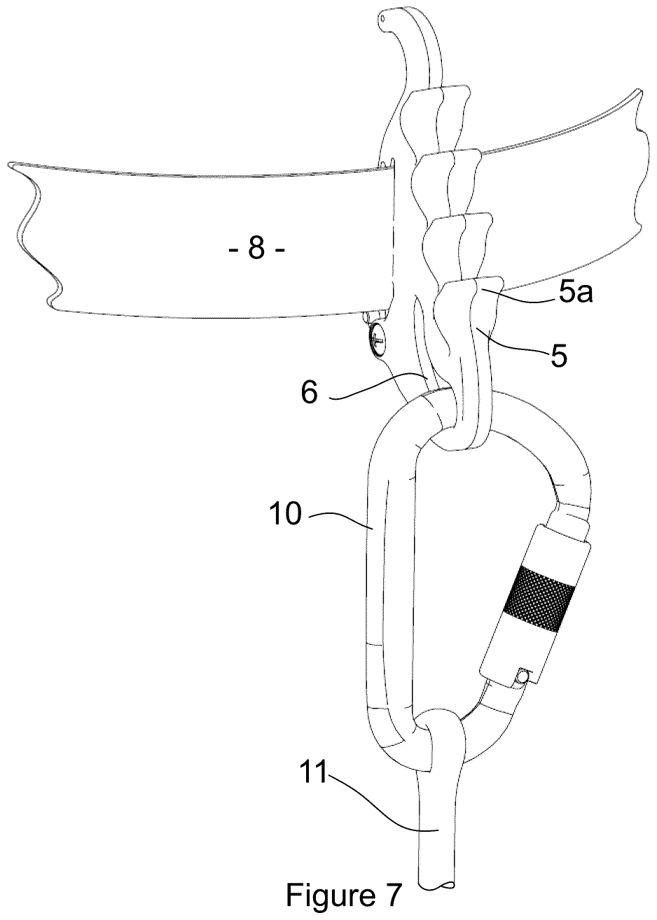

FIG. 7 shows the tool (1) secured to the waist belt (8) of an arborist thereby permitting if required a carabiner (10) to be inserted into the arcuate slot (6) and used for security carrying carabiner 10 with a utensil or tool attached to a tether rope (11) (only part of which is shown). In a similar manner the inwardly facing hook (7) at the upper end of the tool (1) can be used for temporarily parking the carabiner (10) with the utensil or tool and its tether rope (11), although it will be understood that it may also be used for other temporary parking of, for example, the free end of the climber's main safety rope or other sections or loops of rope that may otherwise trail down and pose a potential risk of entanglement.

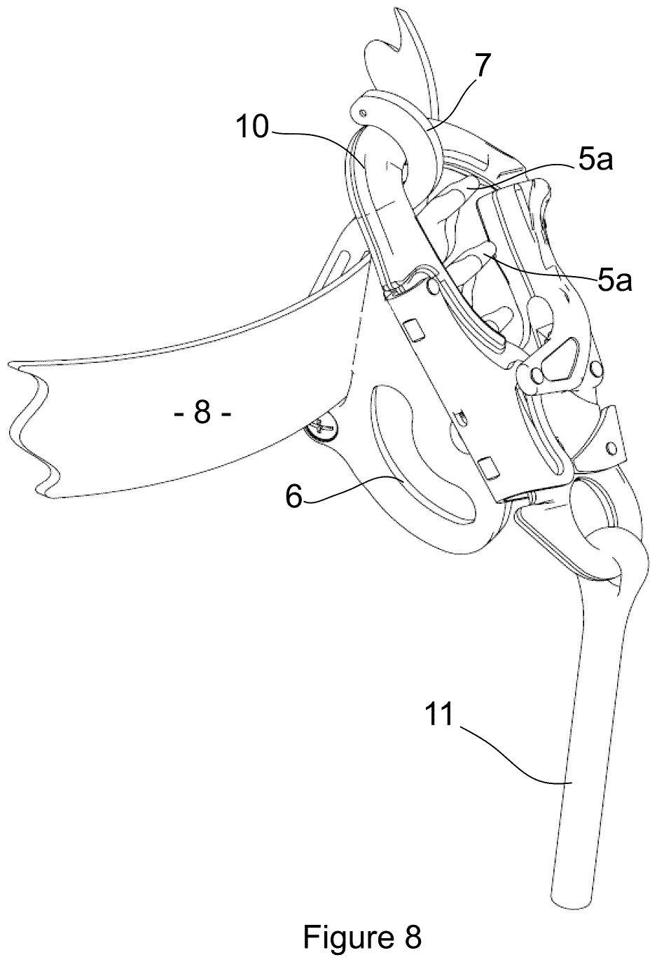

FIG. 8 is similar to FIG. 7 but shows how the inverted hook (7) at the top of the tool can be used for temporarily parking or storing a connector such as a carabiner already attached to the working end of another tether rope, although it will be understood that the hook (7) is not designed to bear any significant weight.

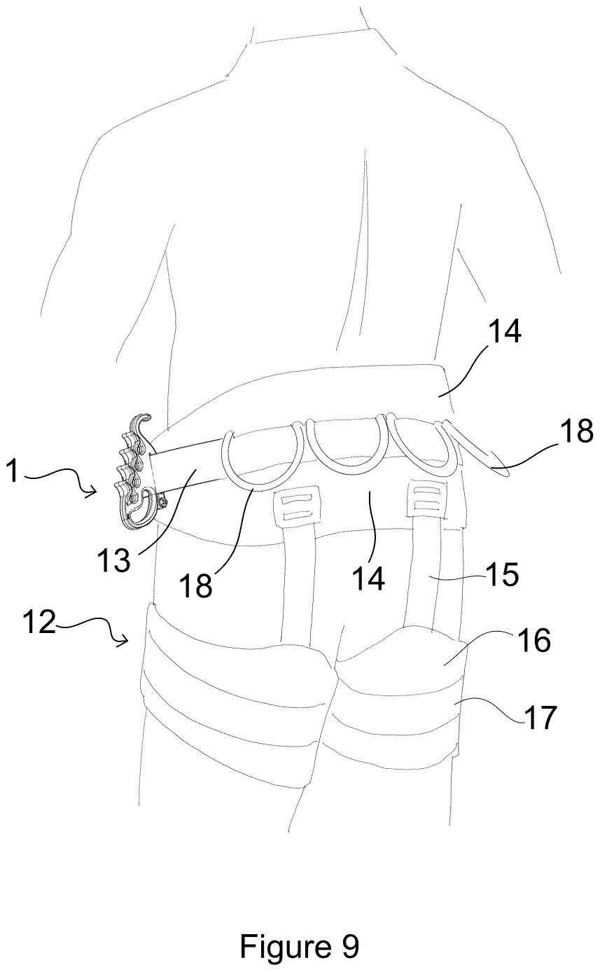

FIG. 9 shows a perspective rear view of a rope climber wearing a climbing harness 12 with the tool 1 of FIG. 1 secured to a waist belt 13 with attendant waist belt padding 14 for providing comfort to the climber and from below which extend adjustable leg straps 15 leading to leg padding 16 behind attendant leg straps 17, collectively with which the climber can comfortably adopt a sitting position. Hanging from the harness waist belt 13 is an array of rope loops 18 from which the climber can attach climbing gear such as extra carabiners as required.

Thus, the invention provides a single rope management tool (1) with multiple useful functions for the arborist, rope climber or in other circumstances where multiple ropes are in use, with minimal space being occupied on the waist belt or harness. This means that two or more such rope management tools can be used simultaneously where, for example, a group of trees are being worked on at the same time and height, one such tool for each set of safety ropes and lanyards where, in each case, because of the vertical orientation of the fingers (5), the accessory slot (6) and hook (7), minimal horizontal space is used up on the waist belt or harness whilst still providing multiple working opportunities to the arborist or climber.

1. A tool for managing a rope associated with a waist belt of an arborist or a climber's harness, comprising:
a main body having a proximal end configured to attach to the waist belt or climber's harness and a distal end configured to point away from the arborist or climber;
a plurality of fingers extending outwardly from the main body of the tool in a descending stair-like array, the plurality of fingers including a topmost finger configured to be nearest to the user of the tool and a lowermost finger extending furthest from the user, the plurality of fingers each configured to receive a section of the rope, each finger having a generally serpentine shape defining in conjunction with an adjacent finger a rope-receiving slot with a closed end in the form of a cavity configured to receive a section of the rope, a tip of each finger being bendable for inserting or releasing a section of the rope.

2. The tool of claim 1 in which at least the plurality of fingers comprise an elastomeric plastic.

3. The tool of claim 2 in which the elastomeric plastic comprises thermoplastic urethane (TPU).

4. The tool of claim 1 wherein the main body includes an accessory slot comprising a curvilinear hole configured to receive a carabiner or connector.

5. The tool of claim 1 wherein the main body includes an inwardly facing hook above the plurality of fingers configured to receive loose ends of the rope.

6. The tool of claim 1 further including a pair of jaws configured to receive and secure the waist belt or harness of the arborist or climber.

7. The tool of claim 6, further including a fastener for fastening the pair of jaws.

8. The tool of claim 7, wherein the fastener is of the threaded barrel nut and bolt type in which the nut has a cylindrical outer surface, co-operable with a bore at the end of each jaw to minimise frictional wear.

9. The tool according to claim 6 wherein each jaw includes inwardly facing teeth configured to grip the waist belt or climbers harness.

10. A waist belt or climber's harness to which the rope management tool according to claim 1 is permanently attached.
